(19) United States
(12) Patent Application Publication
(10) Pub. No.: US 2024/0160456 A1
(43) Pub. Date: May 16, 2024

(54) METHOD AND ELECTRONIC DEVICE FOR PROVIDING PERSONALIZED MENU

(71) Applicant: SAMSUNG ELECTRONICS CO., LTD., Suwon-si (KR)

(72) Inventors: Keeho SONG, Suwon-si (KR); Hoshin SON, Suwon-si (KR); Sungwon KIM, Suwon-si (KR)

(73) Assignee: SAMSUNG ELECTRONICS CO., LTD., Suwon-si (KR)

(21) Appl. No.: 18/541,037

(22) Filed: Dec. 15, 2023

Related U.S. Application Data
(63) Continuation of application No. PCT/KR2023/095089, filed on Nov. 16, 2023.

(30) Foreign Application Priority Data
Nov. 16, 2022 (KR) 10-2022-0153984

(51) Int. Cl. G06F 9/451; H04L 67/303

(52) U.S. Cl. CPC G06F 9/451; H04L 67/303

(57) ABSTRACT

A method is performed by an electronic device. The method includes: obtaining an application use history of the electronic device; determining first applications of the electronic device, based on the application use history of the electronic device; identifying a user group including a user of the electronic device, based on information about the first applications; performing an correlation analysis with respect to a plurality of applications including the first applications, based on an application use history of other electronic devices of the user group; based on a result of the correlation analysis and the information about the one or more first applications, determining one or more second applications to be recommended to the user of the electronic device; generating a personalized application menu including the first applications and the second applications; and displaying the personalized application menu.

### CROSS-REFERENCE TO RELATED APPLICATIONS

This application is a by-pass continuation application of International Application No. PCT/KR2023/095089, filed on Nov. 16, 2023, which is based on and claims priority to Korean Patent Application No. 10-2022-0153984, filed on Nov. 16, 2022, in the Korean Intellectual Property Office, the disclosures of which are incorporated by reference herein their entireties.

### BACKGROUND

### 1. Field

An electronic device for generating a personalized menu for providing convenience of use of an application/source to a user and an operating method of the electronic device are provided.

### 2. Description of the Related Art

In an electronic device, various services are provided to a user through various applications and sources. There are a large number of applications/sources available in an electronic device, and as a user uses various services, the number of applications/sources increases. However, a screen area displaying the applications/sources on a screen of an electronic device is limited, and thus, access convenience for the user with respect to the applications/sources is reduced. Also, when a selection menu of the application and a selection menu of the source are provided through separate menus, a number of menu shifting manipulations are required for the user to use the source after using the application or to use the application after using the source. Thus, various algorithms for simplifying the user's menu manipulations and providing a user interface including a personalized menu corresponding to the user's preferences have been recently used.

### SUMMARY

According to an aspect of the disclosure, a method for displaying a personalized menu on a screen of a display is performed by an electronic device. The method includes: obtaining an application use history of the electronic device; determining one or more first applications of the electronic device, based on the application use history of the electronic device; identifying a user group including a user of the electronic device, based on information about the one or more first applications; performing an correlation analysis with respect to a plurality of applications including the one or more first applications, based on an application use history of other electronic devices of the user group; based on a result of the correlation analysis and the information about the one or more first applications, determining one or more second applications to be recommended to the user of the electronic device; generating a personalized application menu including the one or more first applications and the one or more second applications; and displaying the personalized application menu.

According to an aspect of the disclosure, an electronic device for displaying a personalized menu, includes: a communication interface; an input interface to which one or more sources are to be connected; a display; a memory storing one or more instructions; and at least one processor configured to execute the one or more instructions to: obtain an application use history of the electronic device; based on the application use history of the electronic device, determine one or more first applications, which are mainly used applications of the electronic device; identify a user group including a user of the electronic device, based on information about the one or more first applications; perform a correlation analysis with respect to a plurality of applications including the one or more first applications, based on an application use history of other electronic devices of the user group; based on a result of the correlation analysis and the information about the one or more first applications, determine one or more second applications to be recommended to the user of the electronic device; generate a personalized application menu including the one or more first applications and the one or more second applications; and display the personalized application menu on a screen of the display.

According to an aspect of the disclosure, a non-transitory computer-readable recording medium storing computer program, which, when executable by at least one processor, causes the at least one processor to execute: obtain an application use history of the electronic device; based on the application use history of the electronic device, determine one or more first applications, which are mainly used applications of the electronic device; identify a user group including a user of the electronic device, based on information about the one or more first applications; perform a correlation analysis with respect to a plurality of applications including the one or more first applications, based on an application use history of other electronic devices of the user group; based on a result of the correlation analysis and the information about the one or more first applications, determine one or more second applications to be recommended to the user of the electronic device; generate a personalized application menu including the one or more first applications and the one or more second applications; and display the personalized application menu on a screen of the display.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for schematically describing a personalized application menu provided by an electronic device, according to an embodiment of the disclosure;

FIG. 2 is a flowchart for describing a method, performed by an electronic device, of displaying a personalized application menu, according to an embodiment of the disclosure;

FIG. 3 is a diagram for describing applications, sources, and a personalized menu of an electronic device, according to an embodiment of the disclosure;

FIG. 4A is a diagram for describing an operation, performed by an electronic device, of obtaining a use history of an application/source, according to an embodiment of the disclosure;

FIG. 4B is a diagram for describing a result of determining, via an electronic device, first applications/sources, according to an embodiment of the disclosure;

FIG. 5A is a diagram for describing a result of analyzing, via an electronic device, a correlation relationship between a plurality of applications/sources, according to an embodiment of the disclosure;

FIG. 5B is a diagram for describing an operation, performed by an electronic device, of classifying a plurality of applications/sources based on correlation coefficients, according to an embodiment of the disclosure;

FIG. 6A is a diagram for describing an operation, performed by an electronic device, of automatically generating a personalized menu, according to an embodiment of the disclosure;

FIG. 6B is a diagram for describing an example of a personalized menu generated by an electronic device according to an embodiment of the disclosure;

FIG. 6C is a diagram for describing an example of a personalized menu generated by an electronic device, according to an embodiment of the disclosure;

FIG. 6D is a diagram for describing an example of a personalized menu generated by an electronic device, according to an embodiment of the disclosure;

FIG. 7 is a flowchart of operations performed by an electronic device in conjunction with a server, according to an embodiment of the disclosure;

FIG. 8 is a block diagram of a configuration of an electronic device according to an embodiment of the disclosure; and

FIG. 9 is a block diagram of a configuration of a server according to an embodiment of the disclosure.

### DETAILED DESCRIPTION

Throughout the disclosure, the expression “at least one of a, b or c” may indicate “a,” “b,” “c,” “a and b,” “a and c,” “b and c,” “all of a, b, and c,” or variations thereof.

The terms used in the disclosure are general terms as possible that have been widely used nowadays in consideration of the functions in the disclosure, which, however, may be changed according to an intention of a technician in the art, a precedent, the advent of new technologies, or the like. Also, particular cases may include terms arbitrary selected by an applicant, and in this case, the meaning of the terms will be described in detail in the corresponding description. Therefore, the terms used in the disclosure should be defined based on the meanings of the terms and the content throughout the disclosure, rather than simply based on the titles of the terms.

A singular expression may include a plural expression, unless an apparently different meaning is indicated in the context. The terms used herein including technical or scientific ones may have meanings that are the same as the meanings generally understood by one of ordinary skill in the art described in this specification. Also, while the terms including an ordinal number, such as “first” or “second,” used in this specification may be used to describe various elements, these elements shall not be limited by those terms. These terms are used only for distinguishing one element from another element.

Throughout the specification, when a portion is referred to as “including” an element, the portion may further include other elements, rather than excluding other elements, unless particularly contrary meanings are described. Also, terms such as “unit,” “module,” etc., described in the specification indicate a unit that processes at least one function or operation, and the unit may be embodied in a hardware manner, a software manner, or a combination of the hardware manner and the software manner.

Hereinafter, an embodiment of the disclosure will be described in detail with reference to the accompanying drawings, so that the embodiment of the disclosure may be easily implemented by one of ordinary skill in the art. However, the disclosure may have different forms and should not be construed as being limited to the embodiment of the disclosure described herein. Also, in the drawings, parts not related to descriptions are omitted for the clear description of the disclosure, and throughout the specification, like reference numerals are used for like elements. In addition, the reference numerals of each drawing are only used to describe each drawing, and different reference numerals used in different drawings are not intended to indicate different elements. Hereinafter, the disclosure is described in detail with reference to the accompanying drawings.

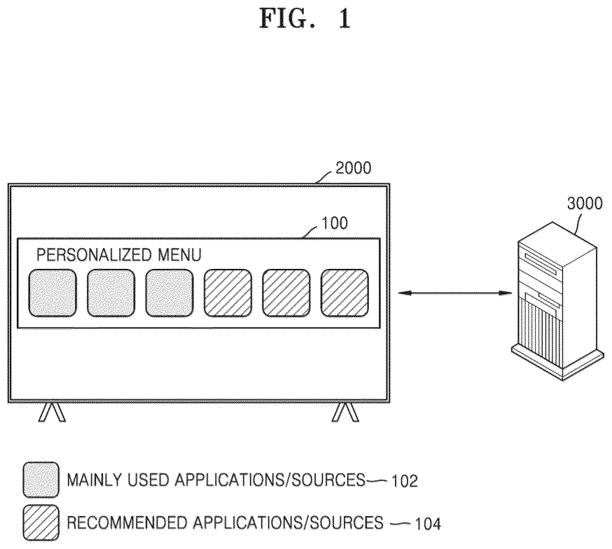

FIG. 1 is a diagram for schematically describing a personalized application menu provided by an electronic device, according to an embodiment of the disclosure.

According to an embodiment of the disclosure, an electronic device 2000 may be a device configured to output an image and/or a video image by including a display. For example, the electronic device 2000 may include a smart television (TV), a smartphone, a tablet personal computer (PC), a laptop PC, a frame-type display, etc. but is not limited thereto and may be realized as various types and forms of electronic devices including displays.

The electronic device 2000 may execute an installed application or provide content, etc. received from a connected source to a user. The electronic device 2000 according to an embodiment of the disclosure may generate a personalized menu 100 through which an application/source may be conveniently selected and executed in the electronic device 2000 and may output the personalized menu 100 on a display of the electronic device 2000.

The personalized menu 100 may include items of a mainly used application/source 102 determined based on an application use history and source use history of the electronic device 2000 and items of a recommended application/source 104 proposed to a user of the electronic device 2000. The recommended application/source 104 may be determined based on an application use history and source use history of the electronic device 2000 and electronic devices of other users. The electronic devices of other users may be the same types or substantially the same types of electronic devices as the electronic device 2000 and may include, for example, an electronic device of another user, another electronic device of the user of the electronic device 2000 except the electronic device 2000, etc. In detail, when the electronic device 2000 is a TV, the electronic devices of other users may include another TV possessed by the user of the electronic device 2000, a TV of another user, etc.

The electronic device 2000 may transmit and receive, to and from a server 3000, data necessary to generate the personalized menu 100. For example, the electronic device 2000 may transmit an application use history and a source use history to the server 3000. The server 3000 may collect the application use history and the source use history from the electronic device 2000 and the electronic devices of other users and may classify electronic devices having similar use histories to generate a plurality of user groups. Also, the electronic device 2000 may receive use histories of a user group and electronic devices of the user group from the server 3000 and may perform a correlation analysis of a plurality of applications/sources. Based on a result of the correlation analysis, the electronic device 2000 may further perform operations for generating the personalized menu 100.

Specific operations, performed by the electronic device 2000, of generating and displaying the personalized menu 100 will be described in more detail with reference to the drawings below and their descriptions.

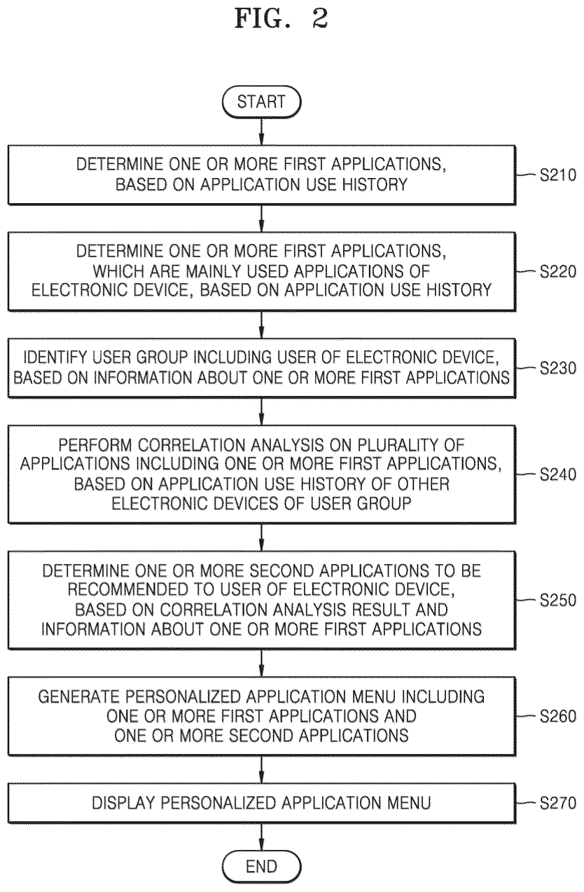

FIG. 2 is a flowchart for describing a method, performed by an electronic device, of displaying a personalized application menu, according to an embodiment of the disclosure.

In operation S210, the electronic device 2000 according to an embodiment of the disclosure may obtain an application use history of the electronic device 2000. The electronic device 2000 may generate the application use history by collecting a history of applications executed by the electronic device 2000 for a predetermined time period. In an embodiment, the application use history may correspond to, for example, daily, weekly, monthly, time-based, and/or day-based statistical data that is/are generated based on the use duration time, the time slot of use, the day of use, the number of execution times, etc. of an application but is not limited thereto. The applications executed in the electronic device 2000 may include, for example, an over-the-top (OTT) media service application, a video application, a game application, etc. but is not limited thereto.

According to an embodiment of the disclosure, the electronic device 2000 may obtain a ‘source’ use history (a use history involving the use of ‘source’). A ‘source’ may refer to other types of electronic devices that are used by being connected to the electronic device 2000 and may provide content and/or media to the electronic device 2000. The electronic device 2000 may generate the source use history by collecting a history of sources used by being connected to the electronic device 2000 for a predetermined time period. The source use history may be collected by the same method as the application use history. In an embodiment, the electronic device 2000 may generate the source use history by collecting a history of sources used by being connected to the electronic device 2000 for a predetermined time period. The source use history may correspond to, for example, daily, weekly, monthly, time-based, and/or day-based statistical data that is/are generated based on the use duration time, the time slot of use, the day of use, the number of execution times, etc. of a source but is not limited thereto.

The ‘sources’ used by being connected to the electronic device 2000 may include, for example, a game console, a set-top box, a desktop PC, a laptop PC, etc. but is not limited thereto.

In operation S220, the electronic device 2000 according to an embodiment of the disclosure may determine, based on the application use history, one or more first applications of the electronic device 2000.

The electronic device 2000 may determine, based on the application use history, the first applications by using a predetermined criterion. The first applications may be, for example, mainly used applications but are not limited thereto. In an embodiment, the electronic device 2000 may classify an application, a monthly accumulated duration time of use of which is N seconds or greater, as the mainly used application, but the electronic device 2000 is not limited thereto.

The electronic device 2000 may determine one or more first sources based on the source use history. In an embodiment, based on the source use history, the electronic device 2000 may determine the first sources as one or more mainly used sources, by using a predetermined criterion. For example, the electronic device 2000 may classify a source, which has a monthly accumulated duration time of use that is M seconds or greater, as the mainly used source, but the electronic device 2000 is not limited thereto.

In an embodiment, the electronic device 2000 may determine, based on the application use history and the source use history, first applications/sources, which are one or more applications/sources.

In operation S230, the electronic device 2000 according to an embodiment of the disclosure may identify a ‘user group’ including the user of the electronic device 2000, based on information about the first applications.

The ‘user group’ refers to a group of users classified according to a similar use pattern based on another application use history and/or the source use history of other electronic devices except for the electronic device 2000. In this case, there may exist the application use history and/or the source use history corresponding to the other electronic devices within the user group.

According to an embodiment of the disclosure, the electronic device 2000 may obtain information about the user group from the server 3000. In this case, the server 3000 may generate a plurality of user groups based on the application/source use histories of other electronic devices of various users. The server 3000 may cluster users having a similar use pattern by using, for example, a clustering algorithm.

According to an embodiment of the disclosure, based on the information about the first applications, the electronic device 2000 may select, from among the plurality of user groups, a user group mainly using applications the same as/substantially the same as the first applications.

According to an embodiment of the disclosure, based on information about the first sources, the electronic device 2000 may select, from among the plurality of user groups, a user group mainly using sources the same as/substantially the same as the first sources of the electronic device 2000. For example, based on the information about the first sources that are mainly used sources of the electronic device 2000, the electronic device 2000 may select, from among the plurality of user groups, a user group mainly using the same/substantially the same sources as the first sources of the electronic device 2000.

In operation S240, the electronic device 2000 according to an embodiment of the disclosure may perform a correlation analysis with respect to a plurality of applications including the first applications, based on the application use history of the other electronic devices of the user group.

By using a correlation analysis algorithm, the electronic device 2000 may calculate correlation coefficients (for example, the Pearson correlation coefficient) between the plurality of applications including the first applications. The electronic device 2000 may perform the correlation analysis based on the application use history of the plurality of applications. For example, the electronic device 2000 may calculate the correlation coefficients between the plurality of applications based on the monthly accumulated use duration time of the plurality of applications, but the electronic device 2000 is not limited thereto. The correlation coefficients may have a value between −1 and 1.

The electronic device 2000 according to an embodiment of the disclosure may perform a correlation analysis between the first sources and perform a correlation analysis between the first applications/sources. This is the same as the example of the correlation analysis with respect to the applications, described above, and thus, its description is omitted.

Based on the correlation coefficients, the electronic device 2000 may classify the applications based on the degree of correlation with respect to the first applications. For example, based on the correlation coefficients, the electronic device 2000 may classify applications having a positive correlation with respect to the first applications as correlation applications. Based on the correlation coefficients, the electronic device 2000 may classify applications having no correlation or little correlation with the first applications as non-correlation applications. Based on the correlation coefficients, the electronic device 2000 may classify applications having a negative correlation with the first applications as inverse-correlation applications.

According to an embodiment of the disclosure, the example of the applications described above may be likewise applied to the first sources. The electronic device 2000 may classify the plurality of sources into correlation sources, non-correlation sources, and inverse-correlation sources. For example, with respect to the first applications/sources that are the mainly used applications/sources of the electronic device 2000, the correlation/non-correlation/inverse correlation applications/sources may be determined, and with respect to the first sources that are the mainly used sources of the electronic device 2000, the correlation/non-correlation/inverse-correlation sources may be determined.

In operation S250, the electronic device 2000 according to an embodiment of the disclosure may determine one or more second applications to be recommended to a user of the electronic device 2000, based on a result of the correlation analysis and the information about the first applications.

The electronic device 2000 may determine at least one of the correlation applications as the second applications. Also, the electronic device 2000 may determine at least one of the non-correlation applications as the second applications. Also, the electronic device 2000 may determine at least one of the inverse-correlation applications as the second applications.

According to an embodiment of the disclosure, the electronic device 2000 may determine the second applications based on a user input. For example, the electronic device 2000 may receive a user input corresponding to one of correlation/non-correlation/inverse-correlation from the user and may determine the second applications.

According to an embodiment of the disclosure, the electronic device 2000 may determine one or more second sources to be recommended to the user of the electronic device 2000.

According to an embodiment of the disclosure, the second applications/sources determined by the electronic device 2000 may be applications/sources that have not been used by the electronic device 2000 or have not been installed in the electronic device 2000.

In operation S260, the electronic device 2000 according to an embodiment of the disclosure may generate a personalized application menu including the first applications and the second applications.

The electronic device 2000 may generate the personalized application menu including the first applications, which are the mainly used applications, and the second applications determined based on the first applications. In this case, the personalized application menu may include the first applications and the second applications, wherein the first applications have a higher priority than the second applications.

According to an embodiment of the disclosure, the electronic device 2000 may generate a personalized application/source menu or a personalized source menu. This is the same as the generating of the personalized application menu, and thus, its description is omitted.

In operation S270, the electronic device 2000 according to an embodiment of the disclosure may display the personalized application menu.

The electronic device 2000 may display the personalized application menu on a screen of a display and may execute a selected application, based on a user input for selecting one of displayed applications.

According to an embodiment of the disclosure, the electronic device 2000 may display the personalized application/source menu or the personalized source menu on a screen of a display.

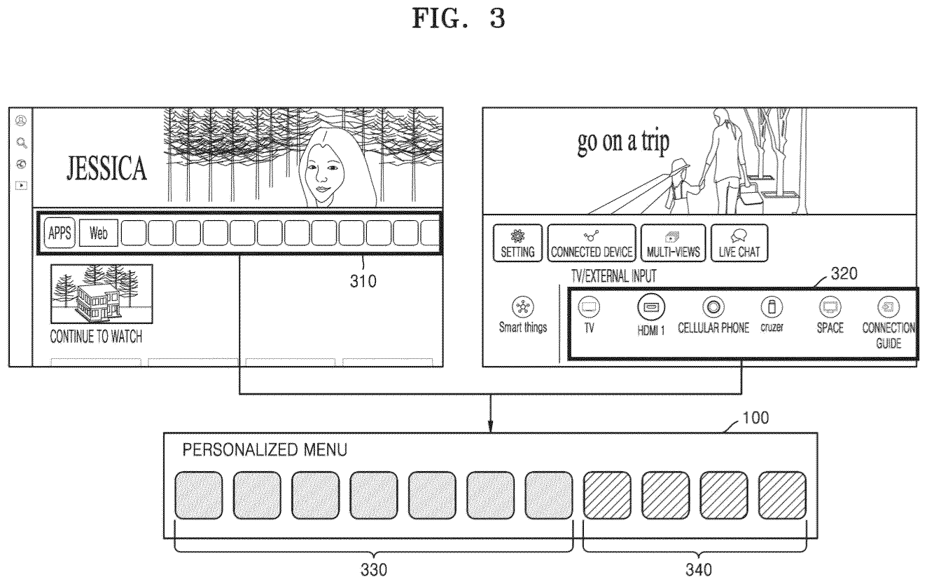

FIG. 3 is a diagram for describing applications, sources, and a personalized menu of an electronic device according to an embodiment of the disclosure.

According to an embodiment of the disclosure, a plurality of applications 310 may be installed in the electronic device 2000. The electronic device 2000 may store various histories which may be obtained as applications are executed and used in the electronic device 2000. The application use histories may include, for example, information of an application (for example, a title of an application, identification information of an application, and a type of an application (for example, an OTT media service application, a video application, a game application, etc.) and information related to a use of an application (for example, the execution time and date of an application, the number of execution times of an application, the execution rate of an application, information about content used in an application, the use time of content used in an application, etc.) but are not limited thereto.

According to an embodiment of the disclosure, various types of external sources 320 may be used by being connected to the electronic device 2000. Various sources may be connected to the electronic device 2000 and may provide content to the electronic device 2000. The electronic device 2000 may store various histories which may be obtained as the source is used by being connected to the electronic device 2000. The source use histories may include, for example, information of a source (for example, a title of the source, identification information of a source, and a type of a source (for example, a set-top box, a game console, a desktop PC, etc.) and information related to a use of a source (for example, the time and date on which a source is connected, the number of connection times, an application executed when a source is connected, information about content used when a source is connected, the time of use of content used when a source is connected, etc.) but are not limited thereto.

As illustrated in FIG. 3, the applications 310 and the sources 320 may be provided through different menus of the electronic device 2000. For example, when a user of the electronic device 2000 wants to use the sources 320 after using the applications 310, a plurality of times of menu shifting manipulations may be required. The electronic device 2000 may provide, to the user, the personalized menu 100 through which the applications 310 and the sources 320 may be available on one menu.

According to an embodiment of the disclosure, the personalized menu 100 may be a personalized application/source menu through which the applications 310 and the sources 320 may be available together on the single menu. In this case, a first item 330 of the personalized menu 100 may display the first applications/sources, which are mainly used applications/sources, and a second item 340 of the personalized menu 100 may display the second applications/sources, which are determined based on the first applications/sources.

According to an embodiment of the disclosure, the personalized menu 100 may be a personalized application menu on which the first applications and the second applications are displayed. Also, the personalized menu 100 may be a personalized source menu on which the first sources and the second sources are displayed.

The electronic device 2000 may receive a user's input for selecting a type of the personalized menu 100 and may display the personalized menu 100 corresponding to the user's input. For example, the electronic device 2000 may display, based on the user's input, any one of the personalized application/source menu, the personalized application menu, and the personalized source menu.

The electronic device 2000 may analyze a use history of the applications 310 and a use history of the sources 320. Based on the use history of the applications 310 and/or the use history of the sources 320, the electronic device 2000 may select a user group including the electronic device 2000 of the user from among user groups using an electronic device.

For example, when the user of the electronic device 2000 mainly uses a video application, the electronic device 2000 may select a user group, which is the user group of other users mainly using the video application, as the user group corresponding to the electronic device 2000. Here, the user group may be generated by grouping users having similar use histories, based on the use history of other electronic devices.

The electronic device 2000 may analyze a correlation relationship between a plurality of applications/sources, based on the use history of applications/sources of the users in the user group. This aspect will be described further with reference to other drawings below.

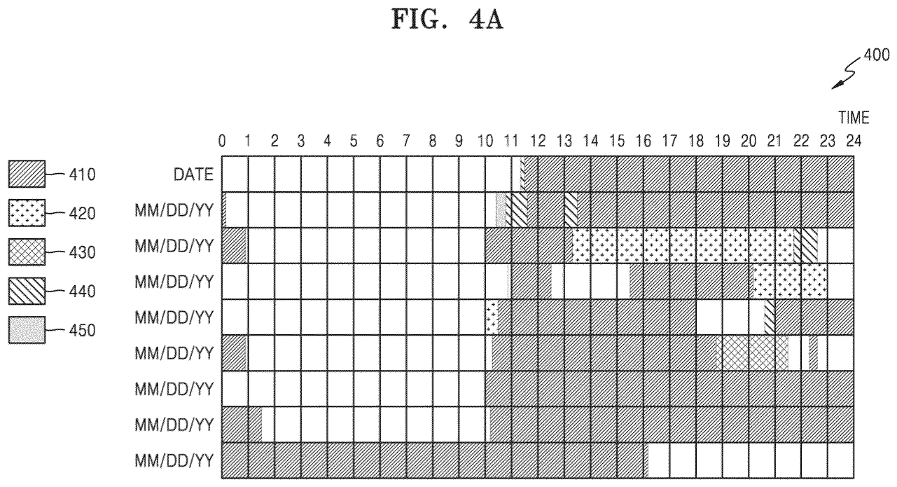

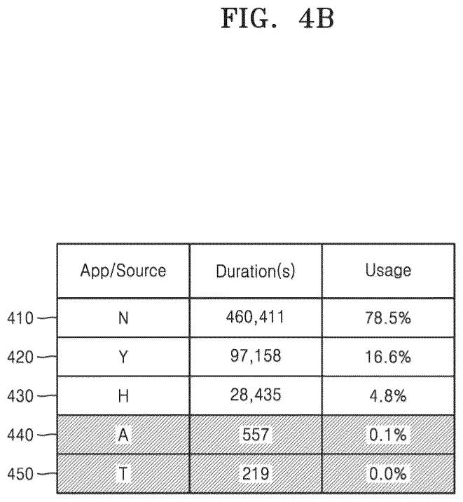

FIG. 4A is a diagram for describing an operation, performed by an electronic device, of obtaining a use history of an application/source, according to an embodiment of the disclosure.

In the descriptions with reference to the drawings below, regardless of whether it is an application or a source, both the application and the source will be indicated by a capital letter. For example, A may indicate an application or a source.

The electronic device 2000 may collect a use history 400 of an application/source used in the electronic device 2000 based on each date and each time slot. The use history 400 of the application/source collected by the electronic device 2000 may be daily/weekly/monthly/time-slot based/day-based statistical data, etc. generated based on the use duration time, the time slot of use, the day of use, the number of execution times, etc.

Referring to the use history 400 of the application/source illustrated in FIG. 4A, it is identified that ‘N 410, Y 420, H 430, A 440, and T 450,’ which are applications or sources, may be used in the electronic device 2000.

The electronic device 2000 according to an embodiment of the disclosure may determine, based on the use history 400 of the application/source, first applications/sources, which are one or more mainly used applications/sources of the electronic device 2000. Also, the electronic device 2000 may determine the first applications that are mainly used applications based on only an application use history and the first sources based on only a source use history.

A result of the determining, via the electronic device 2000, of the first applications/sources that are the mainly used applications/sources will be described further with reference to FIG. 4B.

FIG. 4B is a diagram for describing a result of determining, via an electronic device, first applications/sources, according to an embodiment of the disclosure.

According to an embodiment of the disclosure, the electronic device 2000 may determine, based on the use history 400 of the application/source, the first applications/sources, which are one or more mainly used applications/sources of the electronic device 2000. For example, the electronic device 2000 may determine the mainly used applications/sources based on a monthly accumulated use time of applications/sources. In detail, the electronic device 2000 may determine applications/sources, the monthly accumulated use time of which is a predetermined threshold value or greater, as the first applications/sources. However, the method of determining the first applications/sources is not limited thereto.

As a result of determining, via the electronic device 2000, the first applications/sources, only ‘N 410, Y 420, and H 430’ from among N 410, Y 420, H 430, A 440, and T 450 (applications or sources) may be determined as the first applications/sources.

Based on information about the first applications/sources, the electronic device 2000 may select, from among a plurality of user groups, a user group mainly using the same/substantially the same applications/sources as the first applications/sources. Information about the user group may be obtained from the server 3000. For example, the electronic device 2000 may select, from among the plurality of user groups, a user group using the same/substantially the same applications/sources as ‘N 410, Y 420, and H 430,’ which are the first applications/sources. In this case, users of the selected user group may use other applications/sources in addition to N 410, Y 420, and H 430, and thus, the information about the user group may include an application use history and/or a source use history with respect to the other applications/sources.

The electronic device 2000 may analyze a correlation relationship between the plurality of applications/sources, based on an application use history and/or a source use history of electronic devices of the user group. Here, the plurality of applications/sources may include N 410, Y 420, and H430, which are the first applications/sources described above.

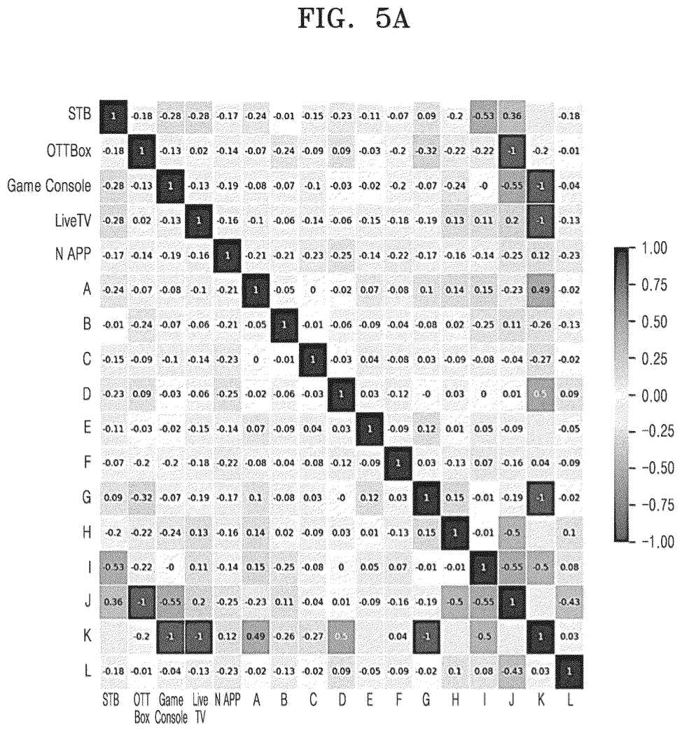

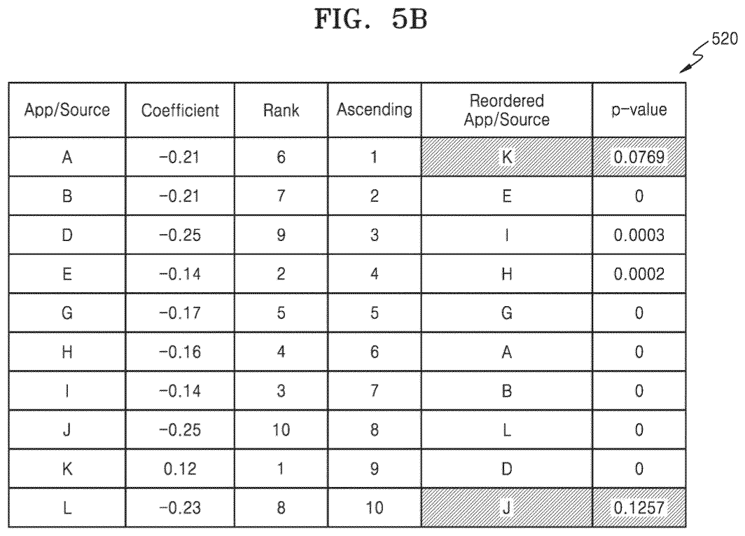

FIG. 5A is a diagram for describing a result of analyzing, via an electronic device, a correlation relationship between a plurality of applications/sources, according to an embodiment of the disclosure.

In describing FIGS. 5A and 5B, as a result of determining, via the electronic device 2000, mainly used applications/sources, application N 510 may be determined as the first application, for example. However, the example in which the first applications/sources include only the N application 510 is described for convenience of explanation, and there may be a plurality of first applications/sources.

According to an embodiment, the electronic device 2000 may analyze a correlation relationship between a plurality of applications/sources including the first applications/sources, based on use histories of applications/sources of electronic devices of a user group. The plurality of “applications/sources” refer to applications/sources used in the electronic device 2000 and other electronic devices corresponding to the user group. For example, the plurality of applications/sources may include a set-top box (a source), an OTT box (a source), a game console (a source), a live TV (an application), the application N 510, which is the first application, and ‘A, B, C, . . . , and N,’ which are other applications/sources.

By using a correlation analysis algorithm, the electronic device 2000 may calculate correlation coefficients (for example, the Pearson correlation coefficient) between the plurality of applications/sources. For example, the electronic device 2000 may calculate the correlation coefficients based on a monthly accumulated use time, which is one of the use histories of the applications/sources, but the electronic device 2000 is not limited thereto. The correlation coefficients may have a value that is between −1 and 1.

Based on the correlation coefficients, the electronic device 2000 may classify the plurality of applications based on a degree of correlation with respect to the first applications/sources. For example, the electronic device 2000 may classify the plurality of applications/sources, based on the application N 510, which is the first application. In detail, based on a predetermined criterion, the electronic device 2000 may classify the plurality of applications/sources into a correlation application/source, a non-correlation application/source, and an inverse-correlation application/source.

For example, the electronic device 2000 may classify applications/sources having a correlation coefficient that is more than 0.1 to 1 or less with respect to the application N 510 as the correlation application/source. Also, the electronic device 2000 may classify applications/sources having a correlation coefficient that is −0.1 or more to 0.1 or less as the non-correlation application/source. Also, the electronic device 2000 may classify applications/sources having a correlation coefficient that is −1 or more to less than −0.1 as the inverse-correlation application/source. However, the criterion values for the classification of the correlation coefficient described above are only examples, and the criterion values are not limited thereto.

Based on the classification of the plurality of applications/sources with respect to the degree of correlation with the first applications/sources, the electronic device 2000 according to an embodiment of the disclosure may determine second applications to be included in the personalized menu 100. For example, the electronic device 2000 may determine at least one of the correlation applications/sources as the second applications. Also, the electronic device 2000 may determine at least one of the non-correlation applications/sources as the second applications. Also, the electronic device 2000 may determine at least one of the inverse-correlation applications/sources as the second applications.

FIG. 5B is a diagram for describing an operation, performed by the electronic device, of classifying a plurality of applications/sources based on correlation coefficients, according to an embodiment of the disclosure.

According to an embodiment of the disclosure, the electronic device 2000 may align the plurality of applications/sources based on the correlation coefficients. Referring to an application/source list 520, the electronic device 2000 may align the plurality of applications/sources, based on correlation coefficients of the plurality of applications/sources ‘A, B, D, E, G, H, I, J, K, and L’ with respect to the application N 510 determined as the first application. For example, a result of the alignment in an ascending order based on the correlation coefficient, performed by the electronic device 2000, may be ‘K, E, I, H, G, A, B, L, D, and J’ in the stated order.

According to an embodiment of the disclosure, based on a p-value obtained as a result of performing the correlation analysis, the electronic device 2000 may exclude, from the application/source list 520, an application/source with respect to which a meaningless correlation coefficient is obtained. For example, the electronic device 2000 may exclude an application/source having the p-value that is 0.25 or more from the application/source list 520. As a result, K and J from among the plurality of applications/sources may be excluded from the application/source list 520 as a result of the correlation analysis.

The electronic device 2000 according to an embodiment of the disclosure may classify applications/sources in the application/source list, based on a predetermined criterion. For example, the electronic device 2000 may classify, based on a predetermined criterion, the plurality of applications/sources into a correlation application/source, a non-correlation application/source, and an inverse-correlation application/source.

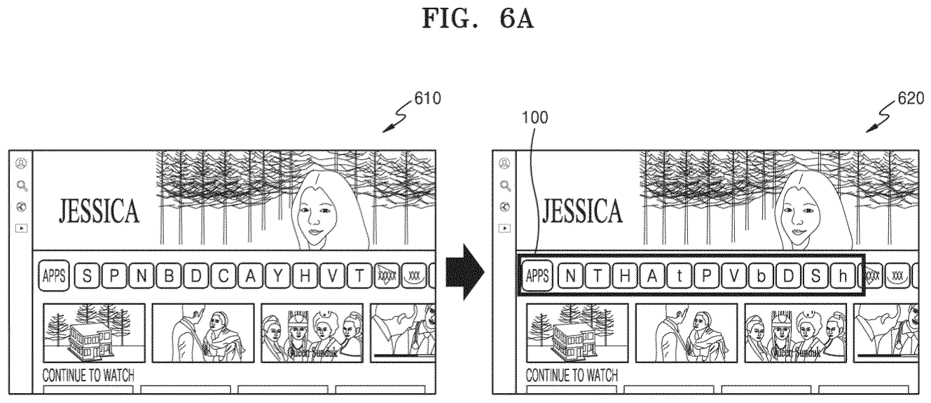

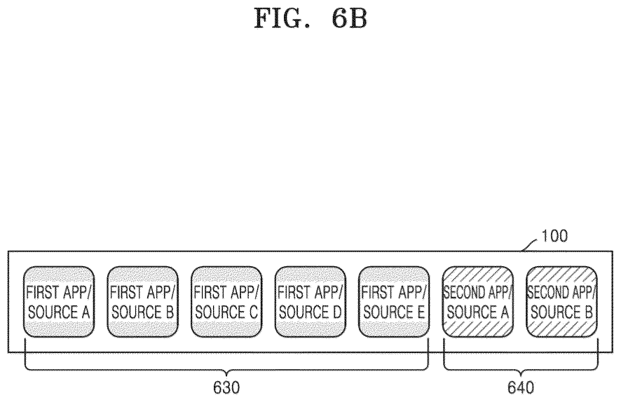

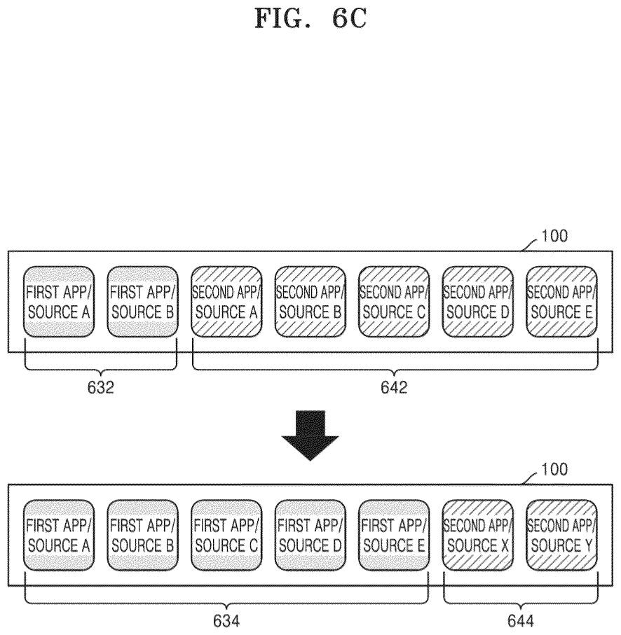

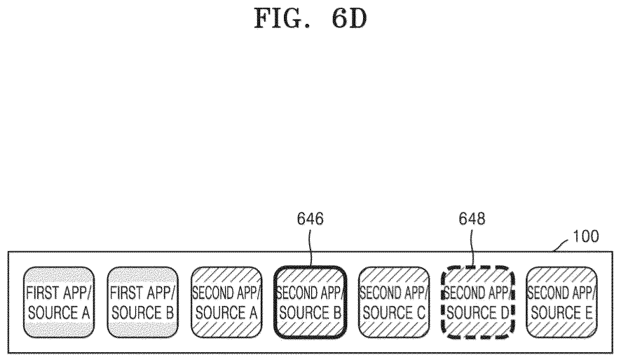

FIG. 6A is a diagram for describing an operation, performed by an electronic device, of automatically generating a personalized menu, according to an embodiment of the disclosure.

A first screen 610 of the electronic device 2000 may be an application menu screen on which applications are displayed. A second screen 620 of the electronic device 2000 may be a screen of the personalized menu 100 which includes first applications/sources that are mainly used applications/sources and second applications/sources that are recommended applications/sources. Applications are indicated in the drawing as capital letters, sources are indicated as small letters.

According to an embodiment of the disclosure, the electronic device 2000 may automatically update the first screen 610 as the second screen 620.

According to an embodiment of the disclosure, the electronic device 2000 may determine the first applications/sources, which are the mainly used applications/sources of the electronic device 2000 and along with the first applications/sources, may determine the second applications/sources, which are to be recommended to the user. As the second applications/sources are determined, the electronic device 2000 may generate the personalized menu 100 including the first applications/sources and the second applications/sources.

As a detailed example, the personalized menu 100 of the second screen 620 may include the first applications ‘N, Y, and H’ determined as the mainly used applications and the second applications/sources ‘t, P, V, b, D, S, and h’ determined as the recommended applications/sources. The second applications/sources may be any one type of correlation applications/sources, non-correlation applications/sources, and inverse-correlation applications/sources.

When the personalized menu 100 is generated, the electronic device 2000 may automatically display the personalized menu 100 on the second screen 620 by automatically updating the first screen 610. By displaying the personalized menu 100, the electronic device 2000 may allow the user of the electronic device 2000 to use the applications and the sources together on one menu.

FIG. 6B is a diagram for describing an example of a personalized menu generated by an electronic device according to an embodiment of the disclosure.

According to an embodiment of the disclosure, first applications/sources 630 may be mainly used applications/sources. Based on a relationship with the first applications/sources 630, the electronic device 2000 may determine second applications/sources 640 to be included in the personalized menu 100.

As a result of analyzing, via the electronic device 2000, a correlation relationship between the first applications/sources 630 and a plurality of other applications/sources based on an application/source use history of a user group, the plurality of applications/sources may be classified into correlation applications/sources, non-correlation applications/sources, and inverse-correlation applications/sources.

The electronic device 2000 may determine at least one of the correlation applications/sources as the second applications/sources 640. The electronic device 2000 may provide, through the personalized menu 100, the second applications/sources 640 in a correlation relationship with the first applications/sources 630, so that the user may receive a recommendation of applications/sources which are similar to the mainly used applications/sources.

The electronic device 2000 may display text along with the personalized menu 100, based on the classification of the second applications/sources 640. For example, the electronic device 2000 may display the text “Recommendation of similar applications/sources,” based on the case that the second applications/sources 640 are the correlation applications/sources. However, the described text is only an example, and the text displayed by the electronic device 2000 is not limited thereto.

The electronic device 2000 may determine at least one of the non-correlation applications/sources as the second applications/sources 640. The electronic device 2000 may provide, through the personalized menu 100, the second applications/sources 640 in a non-correlation relationship with the first applications/sources 630, so that the user may receive a recommendation of new applications/sources in addition to the mainly used applications/sources.

The electronic device 2000 may display text along with the personalized menu 100, based on the classification of the second applications/sources 640. For example, the electronic device 2000 may display the text “Recommendation of new/novel applications/sources,” based on the case that the second applications/sources 640 are the non-correlation applications/sources. However, the described text is only an example, and the text displayed by the electronic device 2000 is not limited thereto.

The electronic device 2000 may determine at least one of the inverse-correlation applications/sources as the second applications/sources 640. The electronic device 2000 may provide, through the personalized menu 100, the second applications/sources 640 in an inverse-correlation relationship with the first applications/sources 630, so that the user may receive a recommendation of other applications/sources having inverse characteristics with respect to the mainly used applications/sources.

The electronic device 2000 may display text along with the personalized menu 100, based on the classification of the second applications/sources 640. For example, the electronic device 2000 may display the text “Recommendation of applications/sources for changing of preferences,” based on the case that the second applications/sources 640 are the inverse-correlation applications/sources. However, the described text is only an example, and the text displayed by the electronic device 2000 is not limited thereto.

According to an embodiment of the disclosure, when the electronic device 2000 provides the personalized menu 1000, the electronic device 2000 may configure the first applications/sources 630 to have a higher priority than the second applications/sources 640. For example, when the electronic device 2000 displays a screen, the electronic device 2000 may arrange the first applications/sources 630 at a place most adjacent to a focused tile and may arrange the second applications/sources 640 next.

According to an embodiment of the disclosure, the electronic device 2000 may display the first applications/sources 630 and the second applications/sources 640 in the personalized menu 100 such that the number of first applications/sources 630 is greater than the number of second applications/sources 640.

However, the electronic device 2000 may determine the second applications/sources 640 based on a user input. For example, the electronic device 2000 may receive, from a user of the electronic device 2000, the user's input for requesting a recommendation of the second applications/sources. In detail, the user of the electronic device 2000 may request a recommendation of correlation applications/sources, may request a recommendation of non-correlation applications/sources, or may request a recommendation of inverse-correlation applications/sources. For example, when the user requests the recommendation of the correlation applications/sources, the electronic device 2000 may determine the correlation applications/sources in the correlation relationship with the first applications/sources 630 as the second applications/sources 640.

FIG. 6C is a diagram for describing an example of a personalized menu generated by an electronic device according to an embodiment of the disclosure.

According to an embodiment of the disclosure, the electronic device 2000 may update the personalized menu 100. For example, as a result of determining, via the electronic device 2000, first applications/sources 632, which are mainly used applications/sources, two applications/sources may be determined as the first applications/sources 632. In this case, second applications/sources 642 determined based on the first applications/sources 632 may be determined.

The electronic device 2000 may update the configuration of the first applications/sources 632, based on a predetermined condition. For example, the electronic device 2000 may repeat, based on a predetermined cycle, the operation of determining the mainly used applications/sources based on a use time of applications/sources. Alternatively, the electronic device 2000 may perform the operation of determining the mainly used applications/sources, based on whether or not the predetermined number of execution times is surpassed. Alternatively, the electronic device 2000 may perform the operation of determining the mainly used applications/sources, based on the user's input for requesting an update.

Also, the number of second applications/sources 642 may be determined based on a result of updating the configuration of the first applications/sources 632. For example, updated first applications/sources 634 may include five applications/sources. Based on the updated first applications/sources 634, the electronic device 2000 may determine new second applications/sources 644. The newly determined second applications/sources 644 may be the same as or different from the second applications/sources 642 before the updating of the first applications/sources 632.

FIG. 6D is a diagram for describing an example of a personalized menu generated by an electronic device according to an embodiment of the disclosure.

According to an embodiment of the disclosure, the second applications/sources of the personalized menu 100 may include a non-used application/source and a non-installed application/source. By recommending a non-used or non-installed application/source, the electronic device 2000 may provide a user with a new use experience.

According to an embodiment of the disclosure, a second application/source B 646 may be a non-used application/source that have not been used in the electronic device 200. When the non-used application/source is included in the personalized menu 100, the electronic device 2000 may display a visual indicator indicating that the application/source is a non-used application/source. For example, the electronic device 2000 may display an edge of the second application/source B 646 differently from an edge of other second applications/sources. However, an embodiment of the disclosure is not limited thereto.

According to an embodiment of the disclosure, a second application/source D 648 may be a non-installed application/source that have not been installed in the electronic device 2000. When the non-installed application/source is included in the personalized menu 100, the electronic device 2000 may display a visual indicator indicating that the application/source is a non-installed application/source. For example, the electronic device 2000 may display an edge of the second application/source D 648 differently from edges of other second applications/sources or the edge of the application/source B 646 that is the non-used application/source. However, an embodiment of the disclosure is not limited thereto.

According to an embodiment of the disclosure, the electronic device 2000 may provide automatic installation of the non-installed application/source. For example, when the personalized menu 100 includes the second application/source D 648, which is the non-installed application/source, the electronic device 2000 may automatically install the second application/source D 648. When the second application/source D 648 is a source, what is installed in the electronic device 2000 may include an application, etc. to use the source, but is not limited thereto.

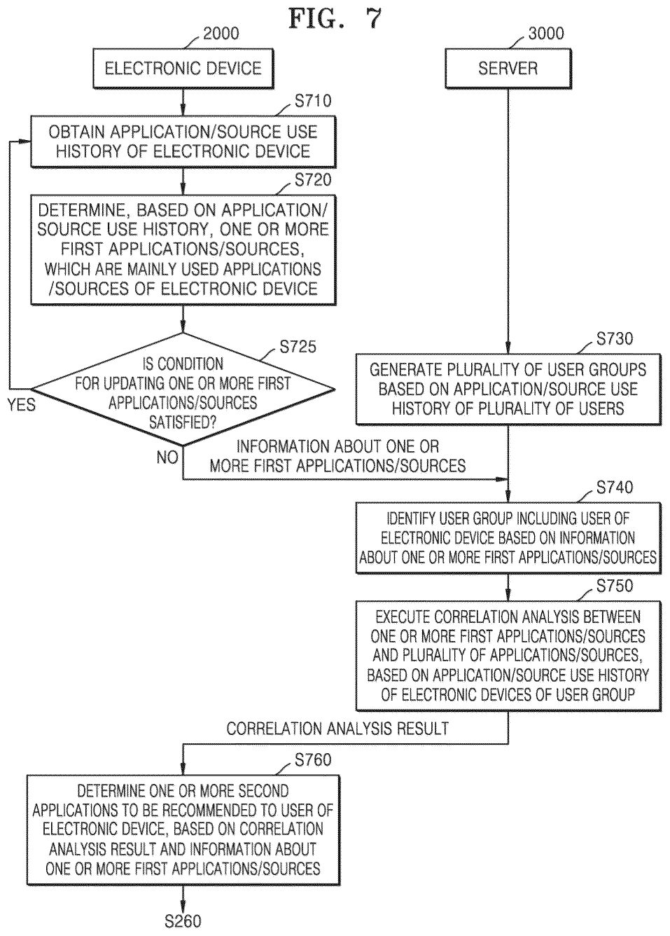

FIG. 7 is a flowchart of operations performed by an electronic device in conjunction with a server, according to an embodiment of the disclosure.

In operation S710, the electronic device 2000 according to an embodiment of the disclosure may obtain an application/source use history of the electronic device 2000. The electronic device 2000 may generate the application/source use history by collecting use histories of applications/sources executed by the electronic device 2000 for a predetermined time period. Operation S710 may correspond to operation S210 of FIG. 2.

In operation S720, the electronic device 2000 according to an embodiment of the disclosure may determine, based on the application/source use history of the electronic device 2000, first applications/sources, which are one or more mainly used applications/sources of the electronic device 2000. Operation S720 may correspond to operation S220 of FIG. 2.

In operation S725, based on whether or not a condition for updating of the first applications/sources is satisfied, the electronic device 2000 according to an embodiment of the disclosure may transmit information about the first applications/sources to the server 3000 or perform operation S710 for updating the first applications/sources. The predetermined condition may vary. For example, the electronic device 2000 may repeatedly perform operation S710 based on a predetermined cycle.

In operation S730, the server 3000 according to an embodiment of the disclosure may generate a plurality of user groups based on the application/source use history of a plurality of users.

The server 3000 may group users of other electronic devices by using use histories of applications/sources included in a use history of a plurality of other electronic devices. The server 3000 may generate the plurality of user groups by classifying adjacent electronic devices having the similar use characteristics into hierarchical tree structures by using a hierarchical clustering algorithm. However, the method, performed by the server 3000, of generating the plurality of user groups is not limited thereto.

In operation S740, the server 3000 according to an embodiment of the disclosure may identify a user group including the user of the electronic device 2000, based on the information about the first applications/sources. The server 3000 may select the user group including the user of the electronic device 2000, based on the information about the first applications/sources received from the electronic device 2000 and information about applications/sources corresponding to the plurality of user groups. Operation S740 may correspond to operation S230 of FIG. 2.

In operation S750, the server 3000 according to an embodiment of the disclosure may perform a correlation analysis with respect to the first applications/sources and the plurality of applications/sources, based on the application/source use history of electronic devices of the user group. Operation S750 may correspond to operation S240 of FIG. 2. The server 3000 may transmit a result of the correlation analysis to the electronic device 2000.

In operation S760, based on the result of the correlation analysis and the information about the first applications/sources, the electronic device 2000 according to an embodiment of the disclosure may determine one or more second applications to be recommended to the user of the electronic device 2000. Operation S760 may correspond to operation S250 of FIG. 2. After operation S760, operations S260 and S270 of FIG. 2 may be performed.

FIG. 7 illustrates that the server 3000 performs operations S730, S740, and S750, but operations of the server 3000 are not limited thereto. For example, operations S720 and S760 may be performed by the server 3000. The server 3000 may transmit information about the first applications/sources and the second applications/sources to the electronic device 2000. The electronic device 2000 may generate the personalized menu 100 including the first applications/sources and the second applications/sources, based on the information received from the server 3000. Alternatively, the server 3000 may generate the personalized menu 100 and may transmit information with respect to the personalized menu 100 to the electronic device 2000.

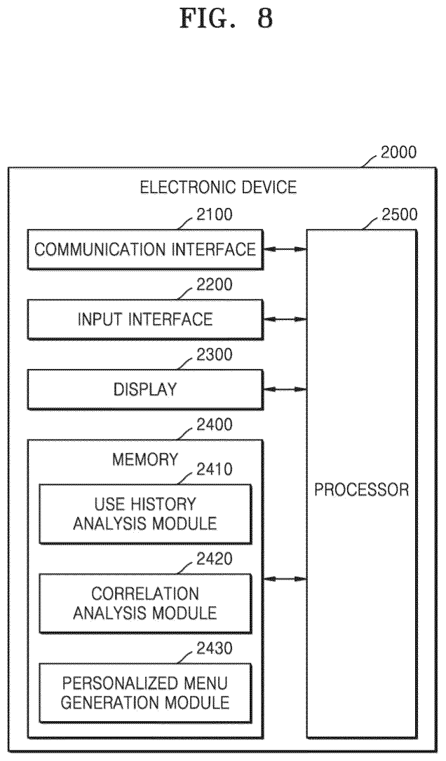

FIG. 8 is a block diagram of a configuration of an electronic device according to an embodiment of the disclosure.

Referring to FIG. 8, the electronic device 2000 according to an embodiment of the disclosure may include a communication interface 2100, an input interface 2200, a display 2300, a memory 2400, and a processor 2500.

The communication interface 2100 may perform data communication with other electronic devices according to control by the processor 2500.

The communication interface 2100 may include communication circuits. The communication interface 2100 may include the communication circuit to perform data communication between the electronic device 2000 and other devices by using at least one of data communication methods including, for example, a wired local area network (LAN), a wireless LAN, Wi-Fi, Bluetooth, Zigbee, Wi-Fi direct (WFD), infrared data association (IrDA), Bluetooth low energy (BLE), near-field communication (NFC), wireless broadband Internet (Wibro), world interoperability for microwave access (WiMAX), a shared wireless access protocol (SWAP), wireless gigabit alliances (WiGig), and radio frequency (RF) communication.

By using the communication interface 2100, the electronic device 2000 may transmit and receive data to perform operations of the electronic device 2000 to and from an external electronic device. For example, the electronic device 2000 may receive information about a plurality of user groups from the server 3000 by using the communication interface 2100. Also, the electronic device 2000 may transmit information about first applications/sources to the server 3000 and may receive a correlation analysis result of the applications/sources from the server 3000, by using the communication interface 2100. Also, the electronic device 2000 may transmit and receive various data to generate/provide the personalized menu 100 to and from the server 3000, etc., by using the communication interface 2100.

The input interface 2200 may receive an image, video, audio, etc. from the outside of the electronic device 2000 according to control by the processor 2500. One or more sources may be connected to the input interface 2200. The input interface 2200 may include, for example, at least one of a high-definition multimedia interface (HDMI) port, a component jack, a PC port, a display port, or a universal serial bus (USB) port, but is not limited thereto.

The display 2300 may output an image signal on a screen of the electronic device 2000 according to control by the processor 2500. For example, the electronic device 2000 may output the screen including the personalized menu 100 through the display 2300.

The memory 2400 may store instructions, data structures, and program codes which may be read by the processor 2500. There may be one or more memories 2400. According to an embodiment of the disclosure, operations performed by the processor 2500 may be implemented by executing the program instructions or the codes stored in the memory 2400.

The memory 2400 may include non-volatile memories, such as read-only memory (ROM) (e.g., programmable ROM (PROM), erasable PROM (EPROM), or electrically EPROM (EEPROM)), flash memory (e.g., a memory card or a solid-state drive (SSD)), and an analog recording type (e.g., a hard disk drive (HDD), a magnetic tape, or an optical disk), and volatile memories, such as random-access memory (RAM) (e.g., dynamic RAM (DRAM) or static RAM (SRAM)).

The memory 2400 according to an embodiment of the disclosure may store one or more instructions and programs for the electronic device 2000 to operate to generate and provide the personalized menu 100. For example, the memory 2400 may store a use history analysis module 2410, a correlation analysis module 2420, and a personalized menu generation module 2430.

The processor 2500 may control general operations of the electronic device 2000. For example, the processor 2500 may execute one or more instructions of a program stored in the memory 2400 to control general operations of the electronic device 2000 for generating and providing the personalized menu 100. There may be one or more processors 2500.

The one or more processors 2500 according to the disclosure may include at least one of a central processing unit (CPU), a graphics processing unit (GPU), an accelerated processing unit (APU), many integrated cores (MIC), a digital signal processor (DSP), or a neural processing unit (NPU). The one or more processors 2500 may be realized as an integrated system on chip (SoC) including one or more electronic components. Each of the one or more processors may be realized as separate hardware (H/W).

The processor 2500 may analyze a use history of applications and/or sources used in the electronic device 2000, by using the use history analysis module 2410. For example, the processor 2500 may collect the use history of the applications and/or sources and may process the use history of the applications and/sources into daily/weekly/monthly/time-based/day-based statistical data, etc. generated based on the use duration time, the time slot of use, the day of use, the number of execution times, etc. The processor 2500 may determine first applications/sources, which are mainly used applications/sources of the electronic device 2000, by using the use history analysis module 2410. Detailed operations with respect to the use history analysis module 2410 are the same as described with reference to the previous drawings, and thus, the same descriptions are omitted.

The processor 2500 may perform a correlation analysis between the first applications/sources which are the mainly used application of the electronic device 2000 and a plurality of applications/sources of a user group, by using the correlation analysis module 2420. In order to perform the correlation analysis, the processor 2500 may identify a user group including a user of the electronic device 2000 based on information about the first applications/sources. Based on a result of the correlation analysis, the processor 2500 may classify the plurality of applications/sources. In this case, the classification of the plurality of applications/sources may indicate a degree of correlation between the plurality of applications/sources and the first applications/sources. The classification of the plurality of applications/sources may include, for example, correlation, non-correlation, inverse-correlation, etc., but is not limited thereto. Based on the result of the correlation analysis, the processor 2500 may determine second applications/sources to be recommended to the user. Detailed operations with respect to the correlation analysis module 2420 are the same as described in detail with reference to the previous drawings, and thus, the same descriptions are omitted.

The processor 2500 may generate and manage the personalized menu 100 by using the personalized menu management module 2430. The personalized menu 100 may include the first applications/sources and the second applications/sources. The processor 2500 may update the personalized menu 100. Detailed operations with respect to the personalized menu management module 2430 are the same as described with reference to the previous drawings, and thus, the same descriptions are omitted.

The modules stored in the memory 2400 and executed by the processor 2500 described above are exemplified for convenience of explanation, and the modules are not necessarily limited thereto. To implement the embodiments of the disclosure described above, other modules may be added, one module may be split into a plurality of modules, each of which is separately provided for each detailed function, and some of the described modules may be combined to be realized as one module.

When the method according to an embodiment of the disclosure includes a plurality of operations, the plurality of operations may be performed by one processor or a plurality of processors. For example, when a first operation, a second operation, and a third operation are performed according to the method according to an embodiment of the disclosure, all of the first to third operations may be performed by a first processor, or the first and second operations may be performed by the first operation (for example, a general-use processor) and the third operation may be performed by a second processor (for example, an artificial intelligence (AI)-dedicated processor). Here, the AI-dedicated processor, an example of the second processor, may perform calculations for the training/inference of an AI module. However, embodiments of the disclosure are not limited thereto

One or more processors according to the disclosure may be realized as a single-core processor or a multi-core processor.

When the method according to an embodiment of the disclosure includes a plurality of operations, the plurality of operations may be executed by one core or a plurality of cores included in one or more processors.

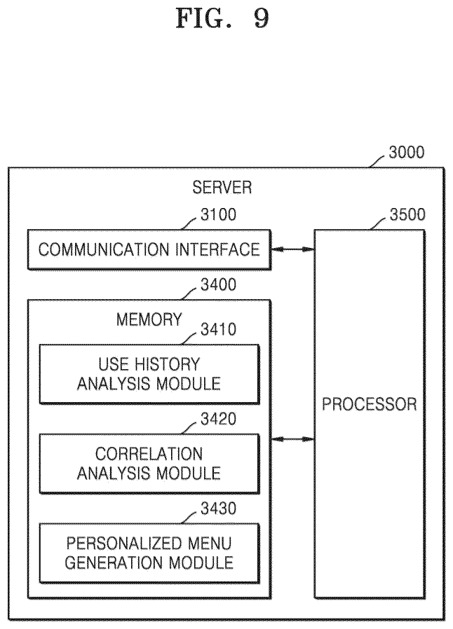

FIG. 9 is a block diagram of a configuration of a server according to an embodiment of the disclosure.

According to an embodiment of the disclosure, at least one of the operations of the electronic device 2000 described above may be performed by the server 3000.

The server 3000 according to an embodiment of the disclosure may include a communication interface 3100, a memory 3400, and a processor 3500. The communication interface 3100, the memory 3400, and the processor 3500 of the server 3000 may correspond to the communication interface 2100, the memory 2400, and the processor 2500 of the electronic device 2000 of FIG. 8, respectively, and thus, the same descriptions are omitted.

The server 3000 according to an embodiment of the disclosure may have a higher computing performance than the electronic device 2000 so as to be able to perform more calculations than the electronic device 2000. The server 3000 may perform clustering of a plurality of users and operations for generating a user group, which require a relatively increased number of calculations. For example, the server 3000 may perform a correlation analysis with respect to the plurality of applications/sources and transmit information about the first applications/sources and the second applications/sources to be included in the personalized menu 100 to the electronic device 2000. The electronic device 2000 may generate the personalized menu 100 including the first applications/sources and the second applications/sources, based on the information received from the server 3000. Alternatively, the server 3000 may generate the personalized menu 100 and may transmit information with respect to the personalized menu 100 to the electronic device 2000.

According to the disclosure, as a method of providing a menu on which applications/sources are available, a method of generating and providing a personalized menu is provided, whereby the personalized menu may be configured to include mainly used applications/sources of a user and recommended applications/sources determined based on correlation analysis with respect to the mainly used applications/sources.

The technical objectives to be achieved by the disclosure are not limited to the technical tasks described above, and other technical tasks that are not described above may be clearly understood by one of ordinary skill in the art from the description below.

According to an aspect of the disclosure, provided is a method, performed by an electronic device, of displaying a personalized menu on a screen of a display. The method may include obtaining, via the electronic device, an application use history. The method may include determining, via the electronic device, one or more first applications based on the application use history. The method may include identifying a user group including a user of the electronic device, based on information about the one or more first applications. The method may include performing correlation analysis with respect to a plurality of applications including the one or more first applications, based on an application use history of electronic devices of the user group. The method may include determining, based on a result of the correlation analysis and the information about the one or more first applications, one or more second applications to be recommended to the user of the electronic device. The method may include generating a personalized application menu including the one or more first applications and the one or more second applications. The method may include displaying the personalized application menu.

In an embodiment, the performing the correlation analysis with respect to the plurality of applications may include calculating correlation coefficients between the plurality of applications by using a correlation analysis algorithm. The performing the correlation analysis with respect to the plurality of applications may include determining, based on the correlation coefficients, correlation applications having a positive correlation with respect to the one or more first applications, non-correlation applications having no correlation with respect to the one or more first applications, and inverse-correlation applications having a negative correlation with respect to the one or more first applications.

In an embodiment, the determining the one or more second applications may include determining at least one of the correlation applications as the one or more second applications.

In an embodiment, the determining the one or more second applications may include determining at least one of the non-correlation applications as the one or more second applications.

In an embodiment, the determining the one or more second applications may include determining at least one of the inverse-correlation applications as the one or more second applications.

In an embodiment, the determining the one or more second applications may include receiving, from a user of the electronic device, the user's input for requesting a recommendation of the one or more second applications. The determining the one or more second applications may include determining, based on the user's input, the one or more second applications as an application classified as one of the correlation applications, the non-correlation applications, and the inverse-correlation applications.

In an embodiment, the one or more second applications may include a non-used application of the electronic device.

In an embodiment, the method may further include updating a first configuration of the one or more first applications, based on a predetermined condition. The method may further include updating, based on information about the one or more first applications having the updated first configuration, a second configuration of the one or more second applications to be recommended to the user of the electronic device. The method may further include updating the personalized application menu to include the one or more first applications having the first updated configuration and the one or more second applications having the second updated configuration.

In an embodiment, in the personalized application menu, the one or more first applications may have a higher priority than the one or more second applications.

In an embodiment, the application use history may include daily/weekly/monthly/time-based/day-based statistical data generated based on at least one of a use duration time, a use time slot, a use day or a number of execution times of an application.

According to an aspect of the disclosure, provided is an electronic device configured to display a personalized menu. The electronic device may include a communication interface, an input interface to which one or more sources are to be connected, a display, a memory storing one or more instructions, and at least one processor configured to execute the one or more instructions stored in the memory. The at least one processor may be configured to execute the one or more instructions stored in the memory to obtain an application use history of the electronic device. The at least one processor may be configured to execute the one or more instructions stored in the memory to determine, based on the application use history, one or more first applications, which are mainly used applications of the electronic device. The at least one processor may be configured to execute the one or more instructions stored in the memory to identify a user group including a user of the electronic device, based on information about the one or more first applications. The at least one processor may be configured to execute the one or more instructions stored in the memory to perform a correlation analysis with respect to a plurality of applications including the one or more first applications, based on an application use history of electronic devices of the user group. The at least one processor may be configured to execute the one or more instructions stored in the memory to determine, based on a result of the correlation analysis and the information about the one or more first applications, one or more second applications to be recommended to the user of the electronic device. The at least one processor may be configured to execute the one or more instructions stored in the memory to generate a personalized application menu including the one or more first applications and the one or more second applications. The at least one processor may be configured to execute the one or more instructions stored in the memory to display the personalized application menu on a screen of the display.

In an embodiment, the at least one processor may further be configured to execute the one or more instructions to calculate correlation coefficients between the plurality of applications by using a correlation analysis algorithm. The at least one processor may further be configured to execute the one or more instructions to determine, based on the correlation coefficients, correlation applications having a positive correlation with respect to the one or more first applications, non-correlation applications having no correlation with respect to the one or more first applications, and inverse-correlation applications having a negative correlation with respect to the one or more first applications.

In an embodiment, the at least one processor may further be configured to execute the one or more instructions to determine at least one of the correlation applications as the one or more second applications.

In an embodiment, the at least one processor may further be configured to execute the one or more instructions to determine at least one of the non-correlation applications as the one or more second applications.

In an embodiment, the at least one processor may further be configured to execute the one or more instructions to determine at least one of the inverse-correlation applications as the one or more second applications.

In an embodiment, the at least one processor may further be configured to execute the one or more instructions to receive, from a user of the electronic device, the user's input for requesting a recommendation of the one or more second applications. The at least one processor may further be configured to execute the one or more instructions to determine, based on the user's input, the one or more second applications as an application classified as one of the correlation applications, the non-correlation applications, and the inverse-correlation applications.

In an embodiment, the one or more second applications may include a non-used application of the electronic device.

In an embodiment, the at least one processor may further be configured to execute the one or more instructions to update a first configuration of the one or more first applications, based on a predetermined condition. The at least one processor may further be configured to execute the one or more instructions to update, based on information about the one or more first applications having the updated first configuration, a second configuration of the one or more second applications to be recommended to the user of the electronic device. The at least one processor may further be configured to execute the one or more instructions to update the personalized application menu to include the one or more first applications having the updated first configuration and the one or more second applications having the updated second configuration.

Embodiments with respect to applications described above may be likewise implemented with respect to sources. That is, the embodiments of the disclosure may be implemented with respect to all of the applications, the sources, and the applications/sources.

Embodiments of the disclosure may be implemented as a recording medium including an instruction executable by a computer such as a program module executable by a computer. Computer-readable recording media may be an arbitrary available medium accessible by a computer and includes all of volatile and non-volatile media and detachable and non-detachable media. Also, the computer-readable media may include computer storage media and communication media. The computer storage media include all of volatile and non-volatile media and detachable and non-detachable media that are realized by an arbitrary method or technique for storing information, such as computer-readable instructions, data structures, program modules, or other data. The communication media may generally include other data of a modulated data signal, such as a computer-readable instruction, a data structure, or a program module.

Also, the computer-readable storage media may be provided in a form of a non-transitory storage medium. Here, the expression of “non-transitory storage medium” may only indicate that the medium is a tangible device, rather than a signal (for example, an electromagnetic wave), and does not distinguish a semi-permanent storage of data in the storage medium and a temporary storage of data in the storage medium. For example, the “non-transitory storage media” may include a buffer temporarily storing data.

According to an embodiment, the method according to various embodiments disclosed in the present specification may be provided as an inclusion of a computer program product. The computer program product may be, as a product, transacted between a seller and a purchaser. The computer program product may be distributed in the form of a machine-readable storage medium (e.g., a compact disc (CD)-ROM) or may be distributed online (e.g., downloaded or uploaded) through an application store or directly between two user devices (e.g., smartphones). In the case of online distribution, at least part of a computer program product (e.g., a downloadable application) may be at least temporarily stored in a machine-readable storage medium, such as a server of a manufacturer, a server of an application store, or a memory of a relay server, or may be temporarily generated.

The above descriptions of the disclosure are examples, and it would be understood by one of ordinary skill in the art that the disclosure may be easily modified as other specific forms without changing the technical concept or essential features of the disclosure. Hence, it will be understood that the embodiments of the disclosure described above are examples in all aspects and are not limiting of the scope of the disclosure. For example, each of components described as a single unit may be executed in a distributed fashion, and likewise, components described as being distributed may be executed in a combined fashion.

The scope of the disclosure is indicated by the claims rather than by the detailed description of the disclosure, and it should be understood that the claims and all modifications or modified forms drawn from the concept of the claims are included in the scope of the disclosure.

What is claimed is:

1. A method, performed by an electronic device, for displaying a personalized menu on a screen of a display, the method comprising:
obtaining an application use history of the electronic device;
determining one or more first applications of the electronic device, based on the application use history of the electronic device;
identifying a user group including a user of the electronic device, based on information about the one or more first applications;
performing an correlation analysis with respect to a plurality of applications including the one or more first applications, based on an application use history of other electronic devices of the user group;
based on a result of the correlation analysis and the information about the one or more first applications, determining one or more second applications to be recommended to the user of the electronic device;
generating a personalized application menu including the one or more first applications and the one or more second applications; and
displaying the personalized application menu.

2. The method of claim 1, wherein the performing the correlation analysis with respect to the plurality of applications comprises:
calculating correlation coefficients between the plurality of applications by using a correlation analysis algorithm; and
based on the correlation coefficients, determining:
correlation applications having a positive correlation with respect to the one or more first applications,
non-correlation applications having no correlation with respect to the one or more first applications, and
inverse-correlation applications having a negative correlation with respect to the one or more first applications.

3. The method of claim 2, wherein the determining the one or more second applications comprises determining at least one of the correlation applications as the one or more second applications.

4. The method of claim 2, wherein the determining the one or more second applications comprises determining at least one of the non-correlation applications as the one or more second applications.

5. The method of claim 2, wherein the determining the one or more second applications comprises determining at least one of the inverse-correlation applications as the one or more second applications.

6. The method of claim 2, wherein the determining the one or more second applications comprises:
receiving, from the user of the electronic device, the user's input for requesting a recommendation of the one or more second applications; and
based on the user's input, determining the one or more second applications as at least one application classified as one of the correlation applications, the non-correlation applications, and the inverse-correlation applications.

7. The method of claim 6, wherein the one or more second applications comprise a non-used application of the electronic device.

8. The method of claim 7, further comprising:
updating a first configuration of the one or more first applications, based on a predetermined condition;
updating, based on information about the one or more first applications having the updated first configuration, a second configuration of the one or more second applications to be recommended to the user of the electronic device; and
updating the personalized application menu to include the one or more first applications having the updated first configuration and the one or more second applications having the updated second configuration.

9. The method of claim 8, wherein, in the personalized application menu, the one or more first applications have a higher priority or higher priorities than the one or more second applications.

10. The method of claim 1, wherein the application use history comprises statistical data, generated based on at least one of a use duration time, a use time slot, a use day, or a number of execution times of an application.

11. An electronic device for displaying a personalized menu, the electronic device comprising:
a communication interface;
an input interface to which one or more sources are to be connected;
a display;
a memory storing one or more instructions; and
at least one processor configured to execute the one or more instructions to:
obtain an application use history of the electronic device;
based on the application use history of the electronic device, determine one or more first applications, which are mainly used applications of the electronic device;
identify a user group including a user of the electronic device, based on information about the one or more first applications;
perform a correlation analysis with respect to a plurality of applications including the one or more first applications, based on an application use history of other electronic devices of the user group;
based on a result of the correlation analysis and the information about the one or more first applications, determine one or more second applications to be recommended to the user of the electronic device;
generate a personalized application menu including the one or more first applications and the one or more second applications; and
display the personalized application menu on a screen of the display.

12. The electronic device of claim 11, wherein the at least one processor is further configured to execute the one or more instructions to:
calculate correlation coefficients between the plurality of applications by using a correlation analysis algorithm; and
based on the correlation coefficients, determine:
correlation applications having a positive correlation with respect to the one or more first applications,
non-correlation applications having no correlation with respect to the one or more first applications, and
inverse-correlation applications having a negative correlation with respect to the one or more first applications.

13. The electronic device of claim 12, wherein the at least one processor is further configured to execute the one or more instructions to determine at least one of the correlation applications as the one or more second applications.

14. The electronic device of claim 12, wherein the at least one processor is further configured to execute the one or more instructions to determine at least one of the non-correlation applications as the one or more second applications.

15. The electronic device of claim 12, wherein the at least one processor is further configured to execute the one or more instructions to determine at least one of the inverse-correlation applications as the one or more second applications.

16. The electronic device of claim 12, wherein the at least one processor is further configured to execute the one or more instructions to:
receive, from the user of the electronic device, the user's input for requesting a recommendation of the one or more second applications; and
based on the user's input, determine the one or more second applications as an application classified as one of the correlation applications, the non-correlation applications, and the inverse-correlation applications.

17. The electronic device of claim 16, wherein the one or more second applications comprise a non-used application of the electronic device.

18. The electronic device of claim 17, wherein the at least one processor is further configured to execute the one or more instructions to:
update a first configuration of the one or more first applications, based on a predetermined condition;
update, based on information about the one or more first applications having the updated first configuration, a second configuration of the one or more second applications to be recommended to the user of the electronic device; and
update the personalized application menu to include the one or more first applications having the updated first configuration and the one or more second applications having the updated second configuration.

19. The electronic device of claim 18, wherein, in the personalized application menu, the one or more first applications have a higher priority or higher priorities than the one or more second applications.

20. A non-transitory computer-readable recording medium storing computer program, which, when executable by at least one processor, causes the at least one processor to execute:
obtain an application use history of the electronic device;
based on the application use history of the electronic device, determine one or more first applications, which are mainly used applications of the electronic device;
identify a user group including a user of the electronic device, based on information about the one or more first applications;
perform a correlation analysis with respect to a plurality of applications including the one or more first applications, based on an application use history of other electronic devices of the user group;
based on a result of the correlation analysis and the information about the one or more first applications, determine one or more second applications to be recommended to the user of the electronic device;
generate a personalized application menu including the one or more first applications and the one or more second applications; and
display the personalized application menu on a screen of the display.
